(19) United States
(12) Patent Application Publication
(10) Pub. No.: US 2019/0007473 A1
(43) Pub. Date: Jan. 3, 2019

(54) PEER-TO-PEER NETWORK LIVE STREAMING SYSTEM AND NODE MANAGEMENT METHOD

(71) Applicant: WANGSU SCIENCE & TECHNOLOGY CO., LTD., Shanghai (CN)

(72) Inventors: Meihui LU, Shanghai (CN); Hong CHEN, Shanghai (CN); Shibiao LV, Shanghai (CN)

(21) Appl. No.: 15/744,578

(22) PCT Filed: Jul. 13, 2017
(86) PCT No.: PCT/CN2017/092790

§ 371 Date: Jan. 12, 2018

(30) Foreign Application Priority Data
Jun. 19, 2017 (CN) 201710465541.5

(51) Int. Cl. H04L 29/06; H04L 29/08; H04N 21/2187

(52) U.S. Cl. CPC H04L 65/60; H04L 67/104; H04L 65/80; H04L 67/02; H04N 21/2187

(57) ABSTRACT

The present disclosure provides a peer-to-peer network live streaming system, comprising at least two nodes and a first server. The first server is used to establish a connection between the nodes to enable the nodes to share node information. At least either of the nodes is configured with an evaluation module and a purging module. The evaluation module calculates and analyzes a health value for the corresponding connected node based on the node information, and feeds the result to the purging module to determine whether to continue to use or purge the evaluated node.

### FIELD OF THE DISCLOSURE

The present disclosure generally relates to the Internet live streaming technology and, more particularly, relates to a live streaming system and a node management method applied to streaming media in a peer-to-peer network.

### BACKGROUND

Peer-to-peer network transmission technology, i.e., P2P technology, is a new communication network transmission technology emerging in the recent years. The P2P network transmission breaks away from the traditional client/server (C/S) model and establishes a direct communication mechanism between client-ends. In the P2P network, each node serves as a client-end and as a server for other client-ends. To certain extent, each node takes an equal position. The P2P network is a successful expansion to the distributed network concept, and distributes server workload under traditional model to each and every node in the P2P network. Thus, not only the server workload is substantially reduced, but also the traffic carrying cost of the content delivery network (CND) is substantially reduced.

In the P2P network, each node (peer) may obtain a large amount of information about other peer nodes from the node management server (aka tracker) and may retrieve data by establishing connections to the other peer nodes. In the existing P2P based live streaming applications, especially for low latency live streaming applications, the requirement for the node performance is stringent. The existing technology primarily depends on the node management server (tracker) for node recommendations. However, the nodes recommended by the node management server (tracker) may be unable to maintain high performing all the time. When a certain node underperforms during live streaming, the live streaming system may not automatically recognize the change and may continue to use the underperforming node. Thus, the overall P2P sharing rate in live streaming applications may be substantially low, the resource allocation efficiency may remain low, and the user experience may be degraded.

### BRIEF SUMMARY OF THE DISCLOSURE

To solve issues in the existing technology, the present disclosure provides a peer-to-peer network live streaming system and a node management method.

One aspect of the present disclosure provides a peer-to-peer network live streaming system, comprising at least a first node and a first server. The first server is used to establish a connection between the first node and another node to enable the first node and another node to share node information. The first node is configured with an evaluation module and a purging module. The evaluation module calculates and analyzes a health value for the another node based on the node information, and feeds the result to the purging module to determine whether to continue to use or purge the evaluated another node.

Another aspect of the present disclosure provides a node management method, comprising: establishing a connection between nodes to enable node information sharing, where the node information includes an initial value of the connected node and a time when a data slice is received by the node; calculating and analyzing a health value for the connected node based on the node information; and determining whether to continue to use or purge the connected node based on the calculation and analysis result.

Another aspect of the present disclosure provides a peer-to-peer network live streaming system, comprising a memory configured to store instructions for implementing the node management method.

Another aspect of the present disclosure provides a peer-to-peer network live streaming system, comprising a processor configured to execute the node management method.

Another aspect of the present disclosure provides a peer-to-peer network live streaming system, comprising: at least one node, where the at least one node is connected with each other and shares node information; an evaluation module configured in the node to calculate and analyze a health value for the connected node based on the shared node information; and a purging module configured to receive results fed by the evaluation module and determine whether to continue to use or purge the evaluated node.

The live streaming system according to the present disclosure includes the first server configured to establish a connection between nodes to enable node information sharing, the evaluation module configured to evaluate a node health value for the node, and the purging module configured to purge poor quality nodes. The evaluation module calculates and analyzes a health value for the node primarily based on the node information, and feeds the analysis result to the purging module such that the purging module determines whether to continue to use or purge the evaluated node. The live streaming system and the node management method according to the present disclosure rapidly screens and purges poor quality peer nodes among a large number of nodes, connects good quality nodes together to obtain the data, improves the sharing rate of the peer-to-peer network, and thus improves the user experience.

### BRIEF DESCRIPTION OF THE DRAWINGS

To more clearly illustrate the technical solution in the present disclosure, the accompanying drawings to be used in the description of the disclosed embodiments are briefly described hereinafter. Obviously, the drawings described below are merely some embodiments of the present disclosure. Other drawings derived from such drawings may be obtained by a person having ordinary skill in the art without creative labor.

FIG. 1 illustrates a schematic diagram of an exemplary live streaming system according to Embodiment 1 of the present disclosure;

FIG. 2 illustrates a flow chart of an exemplary node management method according to Embodiment 1 of the present disclosure;

FIG. 3 illustrates a schematic diagram of an exemplary server and exemplary modules in the live streaming system according to Embodiment 1 of the present disclosure; and

FIG. 4 illustrates a schematic diagram of exemplary modules according to Embodiment 2 of the present disclosure.

### REFERENCE NUMERALS ARE LISTED AS FOLLOWINGS

First server: 10
Second server: 20
Transmitting module: 21
Third server: 30
Fourth server: 40
Nodes: 50, 50A, 50B
Receiving module: 51
Evaluation module: 52
Purging module: 53
Transmitting module: 100
Receiving module: 200
Evaluation module: 300
Purging module: 400

### DETAILED DESCRIPTION

The objectives, features, and advantages of the present disclosure will become clearer from the following description of the embodiments of the present disclosure when taken in conjunction with the accompanying drawings. It should be understood that the specific embodiments described herein are merely illustrative of the present disclosure and are not intended to limit the present disclosure.

The live streaming system and the operation principle in the context of peer-to-peer network provided by the present disclosure will be described in detail below.

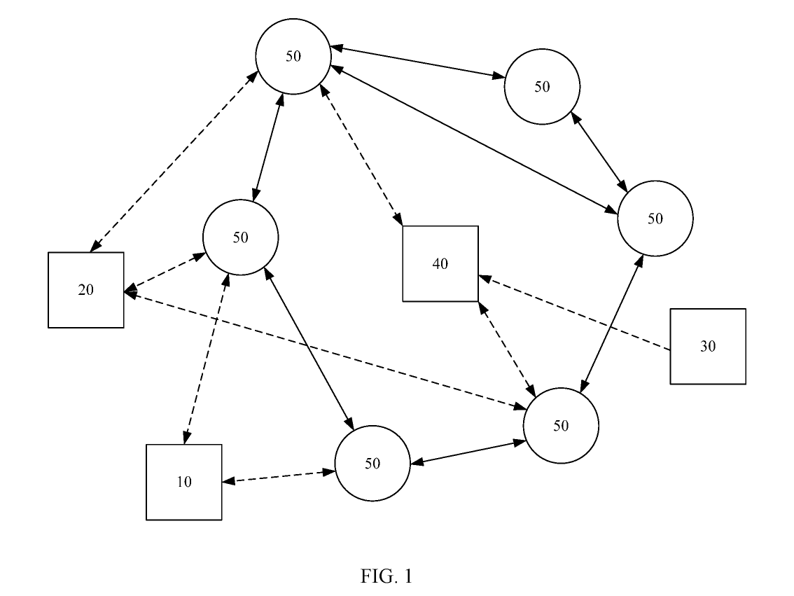

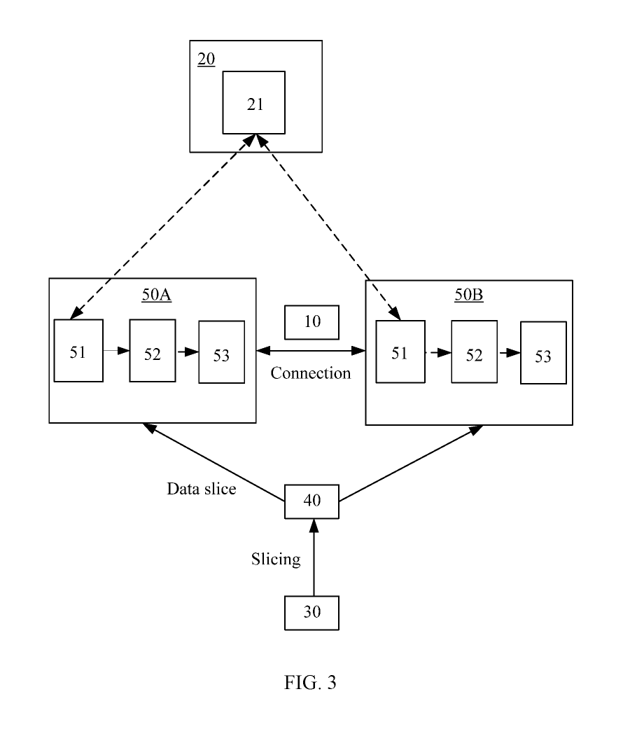

Referring to FIG. 1 through FIG. 3, the live streaming system and the node management method provided by Embodiment 1 may be illustrated. As shown in FIG. 1 and FIG. 3, the live streaming system may be intended for live streaming application in the peer-to-peer network. The live streaming system may include a first server 10, a second server 20, a third server 30, a fourth server 40, and two nodes 50A and 50B.

The first server 10 may be essentially a tunneling server, e.g., openrtmfp server. The openrtmfp server may be a fully open source and cross platform extensible rtmfp server script configured to assist two nodes 50A and 50B to establish a connection. Of course, the first server 10 may be other type of servers that provide identical functions, e.g., stun tunneling server. The first server 10 may establish a connection between the two nodes 50A and 50B such that the two nodes 50A and 50B may share node information.

The second server 20 may provide a management function for all nodes 50A and 50B. The second server 20 may include a transmitting module 21. The transmitting module 21 may first send a node list to the nodes 50A and 50B in response to a client-end request. The node list may be real-time.

The third server 30 may be a slicing server configured to slice live media stream into data slices based on timestamps in the live media stream. The third server 30 may operate as follows. When starting slicing the live media stream into data slices, the third server 30 may first obtain the current system time, i.e., the initial system time t0. The timestamp of the live media stream may start from 0. Then, every time the timestamp of the live media stream increases by Δt, a data slice may be sliced, and the system time plus the current timestamp t0+Δt may be used as the filename and as the file sequence number of the current data slice. That is, the file sequence number of the latest data slice may also represent the time t0+Δt. For example, the live streaming data that has the timestamps 0˜nms may be sliced into a first data slice having a filename 1.FLV. The live streaming data that has the timestamps n˜(n+1)ms may be sliced into a second data slice having a filename 2.FLV. So on so forth. n is a positive integer, and ms is a time unit.

The fourth server 40 is a content distribution network (CDN) server configured to receive the data slices sent by the third server 30, and to distribute the data slices to the nodes 50A and 50B. When running out of the live streaming data, the nodes 50A and 50B may request for more data slices from the fourth server 40.

Each node 50A and 50B may be configured with a receiving module 51, an evaluation module 52, and a purging module 53. Taking the node 50A for example, the receiving module 51 may be used to receive the node list sent by the transmitting module 21 of the second server 20 and node information shared with nodes connected to the node 50A. The evaluation module 52 may calculate and analyze a health value of the node 50B based on the node information, and may feed the health value to the purging module 53. It should be noted that, in one embodiment, the evaluation module 52 may be used to evaluate a corresponding node that is connected to the node where the evaluation module 52 belongs. That is, the evaluation module 52 of the node 50A may not evaluate the node 50A, and may evaluate the health value of the node 50B that is connected to the node 50A. Based on the time represented by the file sequence number of the latest data slice of the live media stream and the node information, the evaluation module 52 may calculate and analyze the health value of the node 50B. The node information may include an initial node value for establishing a connection between peer nodes and a time when the node receives a data slice. The node initial value may be a pre-configured initial health value for the evaluated node 50B after a connection between a pair of nodes (50A and 50B) is established. The pre-configured initial health value may not be fixed, and may be adjusted according to the actual network condition.

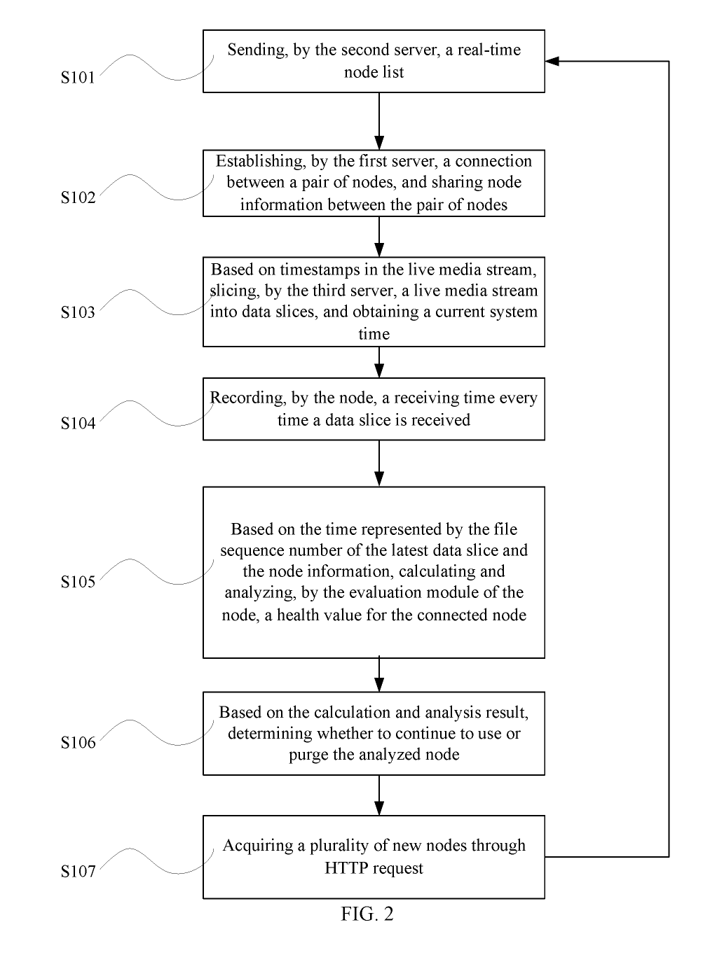

In Embodiment 1, referring to FIG. 2 and FIG. 3, the node management method in the live streaming system may include the following steps.

Step S101: sending, by the second server 20, a real-time node list.

Step S102: establishing, by the first server 10, a connection between a pair of nodes (50A and 50B), and sharing peer node information between the pair of nodes (50A and 50B).

Step S103: based on timestamps in the live media stream, slicing, by the third server 30, a live media stream into data slices, and obtaining a current system time. The detail operation process of the third server 30 may be referred to the previous description, and is not repeated here.

Step S104: assuming that the node 50B is to be evaluated, recording, by the node 50B, a receiving time every time a data slice is received.

Step S105: based on the time represented by the file sequence number of the latest data slice and the node information, calculating and analyzing, by the evaluation module 52 of the node 50A, a health value for the node 50B. The node information may include a node initial value and a time when a data slice is received by the node.

Step S106: feeding, by the evaluation module 52, the calculation and analysis result to the purging module 53. When the health value for the node 50B is high, the quality requirement may be satisfied, the purging module 53 may not purge the peer node 50B, and the pair of nodes (50A and 50B) may remain connected. When the health value for the node 50B is low, the quality requirement may not be satisfied, and the purging module 53 may purge the node 50B.

The evaluation module 52 may use an estimation method as follows. Assuming that a health value of the node is Q, a node initial value is n, and a difference between the time a data slice is received by the node and the time represented by the file sequence number of the latest data slice is m. The calculation time is every time the nodes 50A and/or 50B receive a data slice, the health value is re-calculated by weight. The node health value Q may be approximately equal to the weighted average of the node initial value n and the difference m. When necessary, a certain smoothing factor may be introduced to increase the precision of the health value calculation. Node purging may be based on a weight value or a pre-configured threshold. The calculated health value Q may be compared to the threshold to analyze whether the threshold is crossed to determine whether the node may be purged or may continue to be used. The above estimation method is intended to be illustrative, and may be adjusted according to the actual application scenario. The adjustment may include calculation method and calculation parameters, etc.

Step S107: acquiring, by the node 50, a plurality of new nodes through HTTP request from the second server 20, where the new nodes continue to go through the steps S101˜S106, and so on so forth.

For illustrative purposes, Embodiment 1 of the present disclosure includes a pair of nodes 50A and 50B. In practical applications, the process may not be limited to a pair of nodes. It should be understood that node purging or recommendation result may not be fixed, and may be dynamically changed according to the real-time status of the nodes.

Embodiment 1 of the present disclosure provides a live streaming system, comprising a first server configured to establish a connection between nodes to share node information, a second server configured to transmit a node list, a third server configured to slice live media stream into data slices, a fourth server configured to distribute the data slices to the nodes, an evaluation module configured to evaluate a node health value primarily based on the shared node information, and a purging module configured to determine whether to continue to use or purge the evaluated node based on the evaluation result. The node management method of Embodiment 1 may first establish a connection between the nodes to enable node information sharing. The evaluation module may calculate and analyze a health value for the corresponding node primarily based on the node information, and may feed the analysis result to the purging module such that the purging module may determine whether to continue to use or purge the evaluated node. The node information may depend on the slicing service of the third server, the connection service of the second server, and the distribution service of the fourth server. The live streaming system and the node management method provided by Embodiment 1 of the present disclosure may rapidly screen and purge poor quality nodes among a large number of nodes, connect the good quality nodes together to obtain the data, improve the sharing rate of the peer-to-peer network, and thus improve the user experience. The node purging and recommendation result may not be fixed, and may be adjusted according to the actual status to improve the efficiency of the resource utilization of the live streaming system. The evaluation module may be distributed in each node to improve the efficiency of the evaluation.

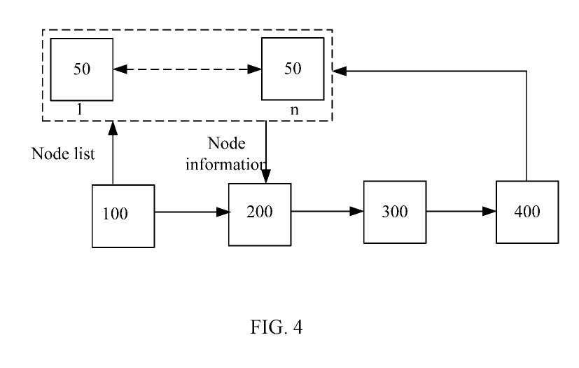

Embodiment 2 of the present disclosure may be illustrated in FIG. 4. The live streaming system provided by Embodiment 2 may include a plurality of nodes 50, a transmitting module 100, a receiving module 200, an evaluation module 300, and a purging module 400.

Based on the client-end response, the transmitting module 100 may transmit a real-time node list to all nodes 50. The receiving module 200 may receive the node list transmitted by the transmitting module 100 and the node information shared by the connected nodes. The evaluation module 300 may calculate and analyze a health value of the node to be evaluated based on the node information, and may feed the evaluation result to the purging module 400. Based on the feedback result, the purging module 400 may determine whether to continue to use or purge the evaluated node. The node information may be the same as in Embodiment 1. The evaluation principle of the evaluation module 400 may be the same as in Embodiment 1, and is not repeated here.

The live streaming system provided by Embodiment 2 of the present disclosure may include n (n is a positive integer greater than 0) number of nodes 50 that are connected, share the node information, and are labeled as 1 through n, the purging module that determines whether to continue to use or purge the evaluated node, and the evaluation module that evaluates the health value of the evaluated node based on the shared node information. Based on the node information, the evaluation module may calculate and analyze the health value for the corresponding node, and may feed the analysis result to the purging module 400 to determine whether to continue to use or purge the evaluated node. In Embodiment 2, the transmitting module 100, the receiving module 200, the evaluation module 300, and the purging module 400 may provide the same or similar functions as the transmitting module 21, the receiving module 51, the evaluation module 52, and the purging module 53 in Embodiment 1. The description is not repeated here. The live streaming system provided by Embodiment 2 of the present disclosure may not be confined to any specific server configuration and architecture. The receiving module 200, the evaluation module 300, and the purging module 400 may not be limited to be configured in the nodes 50. The live streaming system provided by Embodiment 2 of the present disclosure may rapidly screen and purge poor quality nodes among a large number of nodes, connect the good quality nodes together to obtain the data, improve the sharing rate of the peer-to-peer network, and thus improve the user experience. The evaluation module may be distributed in each node to improve the efficiency of the evaluation.

Embodiment 3 of the present disclosure also provides a live streaming system. The live streaming system may include a memory. The memory may store instructions for executing the steps S101˜S107 of the live streaming method.

Embodiment 4 of the present disclosure also provides a live streaming system. The live streaming system may include a hardware processor. The processor may be used to execute the steps S101˜S107 of the live streaming method.

The system embodiments described above are merely for illustrative purpose. The units described as separated parts may or may not be physically detached. The parts displayed as units may or may not be physical units, i.e., may be located at one place, or distributed at a plurality of network units. Based on the actual needs, a part or all of the modules may be selected to achieve the objective of the embodiments. Those ordinarily skilled in the art may understand and implement the disclosed embodiments without contributing creative labor.

Through the descriptions of various aforementioned embodiments, those skilled in the art may clearly understand that the embodiments may be implemented by means of software in conjunction with an essential common hardware platform, or may be simply implemented by hardware. Based on such understanding, the essential part of the aforementioned technical solutions or the part that contribute to the prior art may be embodied in the form of software products. The software products may be stored in computer readable storage media, such as ROM/RAM, magnetic disk, and optical disk, etc., and may include a plurality of instructions to enable a computer device (may be a personal computer, a server, or a network device) to execute the methods described in various embodiments or parts of the embodiments.

The foregoing are merely certain preferred embodiments of the present disclosure, and are not intended to limit the present disclosure. Without departing from the spirit and principles of the present disclosure, any modifications, equivalent substitutions, and improvements, etc. shall fall within the scope of the present disclosure.

1. A peer-to-peer network live streaming system, comprising:
at least two nodes; and
a first server, wherein:
the first server is used to establish a connection between the nodes to enable the nodes to share node information;
at least either of the nodes is configured with an evaluation module and a purging module; and
the evaluation module calculates and analyzes a health value for the corresponding connected node based on the node information, and feeds the result to the purging module to determine whether to continue to use or purge the evaluated node.

2. The live streaming system according to claim 1, wherein:
the node information includes an initial value of the corresponding connected node and a time when a data slice is received by the corresponding connected node.

3. The live streaming system according to claim 2, further including a third server configured to slice a live media stream into data slices according to timestamps in the live media stream.

4. The live streaming system according to claim 3, wherein:
the third server obtains a current system time before starting slicing the live media stream into the data slices.

5. The live streaming system according to claim 4, wherein:
the evaluation module calculates and analyzes a health value for the corresponding connected node based on a time represented by a file sequence number of the latest data slice, the time when the data slice is received by the corresponding connected node, and the initial value of the corresponding connected node.

6. The live streaming system according to claim 1, wherein:
the system continuously obtains a plurality of new nodes from a second server through HTTP request.

7. The live streaming system according to claim 1, wherein:
the evaluation module is configured to evaluate a corresponding node that is connected to the node where the evaluation module is located.

8. A peer-to-peer network node management method, comprising:
establishing a connection between at least a first node and a second node to enable node information sharing, wherein the node information includes an initial value of the connected node and a time when a data slice is received by the second node;
calculating and analyzing a health value for the second node based on the node information; and
determining whether to continue to use or purge the second node based on the calculation and analysis result.

9. The peer-to-peer network node management method according to claim 8, further including:
slicing a live media stream into data slices according to timestamps in the live media stream; and
obtaining a current system time.

10. The peer-to-peer network node management method according to claim 9, further including:
recording the time when the data slice is received by the second node.

11. The peer-to-peer network node management method according to claim 8, further including:
obtaining a plurality of new nodes through HTTP request.

12. The peer-to-peer network node management method according to claim 8, wherein calculating and analyzing a health value for the second node based on the node information includes:
comparing a health value of the second node to a pre-configured threshold or sorting a plurality of health values in order to determine whether to continue to use or purge the second node.

13. A peer-to-peer network live streaming system, the system comprising a memory configured to store instructions for implementing the node management method according to claim 8.

14. A peer-to-peer network live streaming system, the system comprising a processor configured to execute the node management method according to claim 8.

15. A peer-to-peer network live streaming system, comprising:
at least two nodes, wherein the nodes are connected with each other and share node information;
an evaluation module configured in at least either of the nodes to calculate and analyze a health value for the corresponding connected node based on the shared node information; and
a purging module configured to receive results fed by the evaluation module and determine whether to continue to use or purge the evaluated node.

16. The peer-to-peer network live streaming system according to claim 15, further including:
a transmitting module configured to transmit a node list in real-time; and
a receiving module configured to receive the node list transmitted by the transmitting module and the shared node information.

17. The peer-to-peer network live streaming system according to claim 16, wherein:
the node information includes an initial value of the corresponding connected node and the time when the data slice is received by the corresponding connected node.

18. The peer-to-peer network live streaming system according to claim 16, wherein:
the evaluation module calculates and analyzes a health value for the corresponding connected node based on a time represented by a file sequence number of the latest data slice, the time when the data slice is received by the corresponding connected node, and the initial value of the corresponding connected node.

19. The live streaming system according to claim 6, wherein:
according to the evaluation result of the evaluation module, the node where the evaluation module evaluates request the system to continuously obtain a plurality of new nodes from a second server through HTTP request.
